(19) United States
(12) Patent Application Publication
(10) Pub. No.: US 2004/0243290 A1
(43) Pub. Date: Dec. 2, 2004

(54) Method for determining a fault in a pressure sensor or brake circuit

(76) Inventors: Robert Schmidt, Rennerod (DE); Ralf Reviol, Dietzenbach-Steinberg (DE); Ralph Gronau, Wetter (DE); Tobias Scheller, Hofbieber (DE); Andreas Neu, Kuhardt (DE)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/486,495

(22) PCT Filed: Aug. 9, 2002
(86) PCT No.: PCT/EP02/08921

(30) Foreign Application Priority Data
Aug. 11, 2001 (DE) 101 39 676.7

(51) Int. Cl. G06F 7/00

(52) U.S. Cl. 701/34; 340/425.5

(57) ABSTRACT

The invention relates to a method for determining a fault in or failure of a hydraulic pressure sensor or hydraulic brake circuit in a hydraulic vehicle brake system with a vacuum brake booster, with a fault in or failure of a hydraulic pressure sensor or hydraulic brake circuit being determined on the basis of a comparison between a hydraulic pressure or variables derived therefrom and the vacuum situation or point of maximum boosting of the vacuum brake booster or variables derived therefrom.

### TECHNICAL FIELD

The invention generally relates to brake systems and more particularly relates to a method for determining a fault in or failure of a hydraulic pressure sensor or a hydraulic brake circuit in a hydraulic vehicle brake system comprising a vacuum brake booster.

### BACKGROUND OF THE INVENTION

Due to new engine engineering such as, for example, direct injection gasoline engines or very efficient diesel engines, a sufficient vacuum supply for brake boosting with a vacuum brake booster is no longer ensured. In particular during the cold-start phase of the vehicle there is barely enough vacuum available to the booster to allow strong braking of the vehicle.

For this reason, brake systems with “active hydraulic brake boosting” are used; in these systems the brake pressure is increased through a hydraulic unit such as a motor-pump unit. When, in the above-mentioned system, the maximum point of the vacuum brake booster is reached with active hydraulic brake boosting and the driver continues pressing the brake pedal, then—if the vacuum brake booster does not provide adequate assistance—a hydraulic booster unit will cause the pressure to continue to rise so that the driver can obtain the desired braking performance. Thus, at least a part of the brake boosting can be generated actively by the booster unit in these types of methods with “active” hydraulic brake boosting.

The point of maximum boosting of the booster, for example, can be detected by vacuum sensors in the brake booster. One or two (hydraulic) pressure sensors can be used to generate a desired value for the hydraulic brake pressure, with such pressure sensors measuring the hydraulic pressure in both circuits of a tandem brake master cylinder, i.e. the primary brake circuit and the floating piston brake circuit.

If a brake circuit in which the, or one, pressure sensor is arranged fails, the reference variable for the hydraulic brake boosting can no longer be determined directly because there is no pressure sensor signal. If, for example, the primary brake circuit of the tandem brake master cylinder fails already during the cold-start phase due to a leak, then the associated pressure sensor cannot determine any pressure. Due to the missing reference variable, the hydraulic booster unit of the system is not activated, and no hydraulic boosting occurs. On the other hand, the vacuum in the brake booster is not sufficient to provide the necessary pressure to the still intact floating piston or secondary brake circuit of a tandem brake master cylinder so as to fulfill the legal requirements for a minimum deceleration of the vehicle at a defined pedal force. Therefore, this situation has to be reliably recognized so that at least an “emergency boost” is provided in the event of a circuit failure.

### BRIEF SUMMARY OF THE INVENTION

Thus, it is the object of this invention to disclose a method for reliably determining a fault in or failure of a hydraulic pressure sensor and/or hydraulic brake circuit in a hydraulic vehicle brake system. Furthermore, a method which ensures at least the legally stipulated minimum deceleration, even if one pressure sensor fails, is to be additionally provided.

The object of the invention shall be solved by the characteristics of the independent claims. Further embodiments of the invention are stated in the dependent sub-claims.

In accordance with the present invention, the object shall be solved with a method for determining a fault in or failure of a hydraulic pressure sensor and/or hydraulic brake circuit in a hydraulic vehicle brake system comprising a vacuum brake booster, where a fault in or failure of a hydraulic pressure sensor and/or hydraulic brake circuit is determined by comparing a hydraulic pressure or variables derived therefrom with the vacuum pressure situation or the point of maximum boosting of the vacuum brake booster or variables derived therefrom.

The “vacuum situation” is defined in particular through the vacuum prevailing in the working chamber or the pressure difference between working chamber and vacuum chamber. The term “vacuum” refers to a pressure that is less than or equal to the ambient atmospheric pressure.

According to the present invention, the hydraulic pressure is to be determined with at least one hydraulic pressure sensor and the vacuum situation or the maximum boosting of the vacuum brake boosters is to be determined with one or several vacuum sensors.

This means that the hydraulic pressure in the brake circuit concerned or the brake master cylinder concerned is determined by an associated pressure sensor. This sensor can be preferably arranged in a hydraulic line running from the master brake cylinder to the wheel brakes of the vehicle. Accordingly, the hydraulic vehicle brake system preferably comprises a hydraulic pressure sensor that senses the pressure in a hydraulic line from the master brake cylinder to the wheel brakes of the vehicle or in a chamber of a master brake cylinder, such as the tandem brake master cylinder, in order to detect the pressure in a brake circuit.

Here the vacuum situation in the vacuum brake booster preferably is determined by measuring the vacuum with appropriate sensors in the vacuum brake booster. In this connection, a differential pressure vacuum sensor can directly detect the pressure difference between the chambers of the vacuum brake booster or two vacuum sensors are used, each of which separately senses the vacuum in the two chambers. Within the meaning of the invention, a fault in or failure of the hydraulic pressure sensor and/or the brake circuit is determined according to a vacuum determined by the vacuum sensor, of which there should be at least one. Consequently, according to the present invention, the failure of a brake circuit with a hydraulic boost can be determined with the help of the sensors provided in the vacuum brake booster, with the brake circuit failure of the circuit, in which the “defect” pressure sensor is arranged, being detected with the help of the vacuum sensors (in the vacuum and working chambers) provided in the brake system.

According to the present invention, the vacuum or variables derived therefrom is determined in the vacuum brake booster and compared with the hydraulic pressure or variables derived therefrom, and a fault in or failure of the pressure sensor and/or the associated brake circuit is concluded from this comparison.

The present invention provides that the pressures prevailing in a vacuum chamber and a working chamber of the vacuum brake booster are determined by means of two vacuum sensors in relation to the ambient atmospheric pressure (ambient pressure) and that the vacuum situation or the point of maximum boosting of the vacuum brake booster is determined on the basis of these pressures.

Preferably the brake pressure to be introduced is determined on the basis of the signals of the vacuum sensor and the brake pressure being applied is determined by the pressure sensor, with the brake pressure to be introduced and that being applied or variables derived therefrom being compared and a fault in or failure of the pressure sensor and/or the associated brake circuit being concluded from such comparison.

In accordance with the present invention, it is provided that a fault in or failure of the pressure sensor and/or associated brake circuit is then concluded from this, if the brake pressure to be introduced is—in relation to the brake pressure being applied—at least approximately 10%, preferably at least approximately 30%, larger than the brake pressure being applied.

According to the present invention, preferably a fault in or failure of the pressure sensor and/or the associated brake circuited is concluded, if the vacuum situation or maximum boosting of the vacuum brake booster indicates that the driver wants to brake and the desire to brake is detected at least for a certain, predefined period of time, preferably a period of time lying in a range from about 10 msec. to about 150 msec., preferably about 100 msec., and if, at the same time, the hydraulic pressure in the brake circuit concerned is reduced or is very low already.

According to the present invention, it is provided that the desire of the driver to brake is detected when the vacuum brake booster basically is providing its maximum boosting force.

This is so because, for example, a circuit failure can only be reliably detected in a situation, when the driver's desire to brake is above the point of maximum boosting of the vacuum brake booster. Tests have shown that even in the event of a large leakage, e.g. caused by a completely loosened bleeder nipple, back pressure is built up in the brake circuit concerned, since the driver presses the pedal with a certain (customary) “expectation to meet counter force”, which leads to a relatively quick (quicker than normal) activation, even if the pedal is pressed slowly initially. If the pressure in the tandem brake master cylinder drops after the brakes are activated and drops below, for example, a point of maximum boosting calculated by the software on the basis of the vacuum chamber signal, then the pressure in the working chamber has to fall, since the working chamber will be connected to the vacuum chamber again at precisely this point of time. An intact brake system exhibits this kind of behavior. If, however, the pressure in the tandem brake master cylinder drops below the point of maximum boosting due to a leakage (circuit failure) even though the driver continues to apply the brake, the working chamber will not be connected to the vacuum chamber, since the brake has not been activated yet. For this reason, the pressure in the working chamber does not drop in the event of a fault. If this behavior prevails for a certain time, a circuit failure is detected. Such detection can be cancelled if a pressure drop in the working chamber is detected. Thus, an advantage offered by this method is the exact determination of the time when the detection algorithm starts (falling below the level control point).

The booster is providing its maximum boosting force when the point of maximum boosting is reached and this situation basically remains the same, which, in particular, can be determined through the pressure in the working chamber. According to the present invention, the situation when the booster provides maximum boosting force is considered to remain essentially the same when the pressure in the working chamber lies less than 30 mbar, preferably less than 20 mbar, below the pressure at the point of maximum boosting.

In accordance with the present invention, it is provided that the point of maximum boosting is determined on the basis of a pressure-to-pedal travel characteristic curve of the vacuum brake booster or a characteristic curve derived therefrom, such as a pressure-to-pedal force characteristic curve. In this connection, preferably a basic characteristic curve is provided, which can be changed according to the signals of the vacuum sensor. This means that the characteristic curve is adapted to the changing conditions in the brake system in order to optimize the accuracy of the detection of the point of maximum boosting.

According to the present invention, a brake boost method for a vehicle brake system with a hydraulic auxiliary force provides that the hydraulic auxiliary force is controlled according to a detected pressure sensor fault or a failure in the brake circuit, which is recognized on the basis of the method for determining a fault in or failure of a hydraulic pressure sensor and/or hydraulic brake circuit according to the present invention. Hence, regarding a method for introducing brake pressure to the wheel brakes of a vehicle in the event of a brake circuit failure in a brake system exhibiting a hydraulic and a vacuum brake booster, it is of essential importance that the driver's desire to brake is determined with the help of the sensors arranged in the vacuum brake booster and by means of the actuation method of the brake system when the hydraulic boosting is activated and that a suitable brake pressure is introduced.

A sub-object shall be solved by a method for brake boosting in a vehicle brake system having at least two brake circuits with at least one pressure sensor, in which a fault in or failure of a hydraulic pressure sensor and/or hydraulic brake circuit is determined and which is characterized in that hydraulic pressure is built up in a non-involved brake circuit or a brake circuit not associated with the pressure sensor concerned when a fault in or failure of a hydraulic pressure sensor and/or hydraulic brake circuit was determined. The pressure is generated in a still intact brake circuit with hydraulic auxiliary force, preferably by means of a hydraulic pump.

According to the present invention, the method for brake boosting provides that hydraulic pressure is built up when the vacuum situation or the maximum boosting of the vacuum brake booster indicates that the driver wants to brake for a certain, predefined period of time and, at the same time, the hydraulic pressure in the brake circuit concerned drops or already is very low, that the pressure build-up continues when the vacuum situation or the maximum boosting of the vacuum brake booster continues to indicate that the driver wants to brake, and that the pressure build-up is cancelled when the vacuum situation or the maximum boosting of the vacuum brake booster no longer indicates that the driver wants to brake.

In this regard, the driver's wish to brake preferably is considered to have been recognized when the vacuum brake booster basically is providing its maximum boosting force, i.e. when the point of maximum boosting has been reached and this situation essentially remains the same. According to the present invention, the situation of maximum boosting is considered to remain essentially unchanged when the working chamber pressure lies less than 30 mbar, preferably less than 20 mbar, below the pressure of the point of maximum boosting.

According to the present invention, the hydraulic pressure build-up is initiated when a block valve, which is arranged in a hydraulic line between vacuum brake booster or a brake master cylinder connected thereto and a wheel brake, is closed and when an electric motor of a hydraulic pump, which is arranged in the hydraulic line between the block valve and wheel brake, is activated.

According to the present invention, it is provided that hydraulic pressure is decreased when the vacuum situation or maximum boosting of the vacuum brake booster indicates that the driver is releasing the brake.

According to the present invention, it is provided that hydraulic pressure is decreased when a block valve, which is arranged in a hydraulic line between the vacuum brake booster or a brake master cylinder connected thereto and a wheel brake, is opened and the electric motor of a hydraulic pump, which is arranged in the hydraulic line between the block valve and wheel brake, is not activated any longer.

In accordance with the present invention, the block valve is an analog electromagnetic valve.

According to the present invention, when a fault in or failure of a brake circuit is determined, the valves located in this brake circuit are activated in such a way that a loss or further loss of pressure fluid is prevented.

A preferable hydraulic brake system for applying the invention exhibits an activation device, preferably a brake pedal, a vacuum brake booster, an actuable brake master cylinder and a pump, whose pressure can be applied to at least one wheel brake of the vehicle and by means of which a hydraulic brake boost is generated, with it being possible to connect the inlet side (suction side) of such pump to the brake master cylinder via at least one hydraulic connection, in which a change-over valve is arranged, and with it being possible to connect the outlet side (pressure side) of the pump with at least one wheel brake of the vehicle via at least one hydraulic connection and with the brake master cylinder via at least one hydraulic connection, in which a block valve is arranged.

### BRIEF DESCRIPTION OF THE DRAWINGS

FIG. 1 and FIGS. 2a-2c show a tandem brake master cylinder, which essentially exhibits two brake master cylinders arranged in tandem in a housing. Since the force of the driver's foot generally does not suffice, the tandem brake master cylinder is not activated directly by the brake pedal, but via brake boosting control gear by means of suction air, compressed air or hydraulic pressure.

FIG. 3 shows an arrangement suitable for the method according to the present invention on the basis of a brake system with active hydraulic brake boosting.

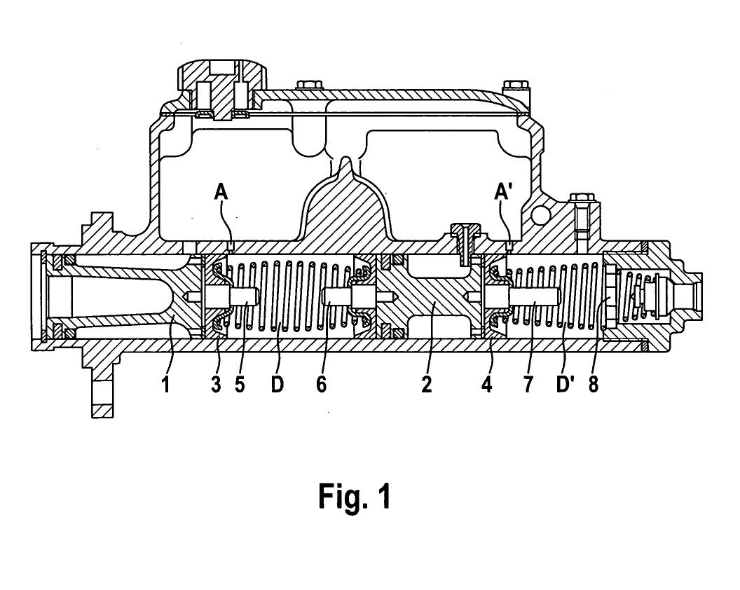

### DETAILED DESCRIPTION OF THE PREFERRED EMBODIMENTS

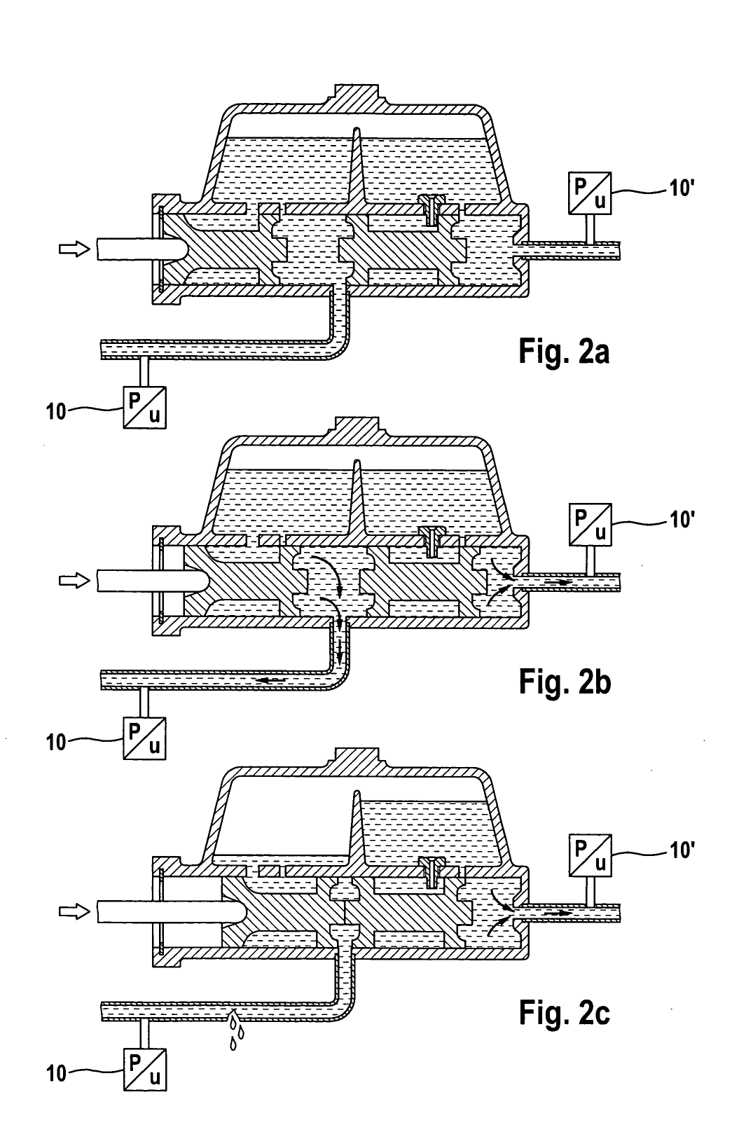

When the primary piston (1) is actuated in the direction of the secondary piston (2), the primary sleeve (3) first travels over the compensating bore (A) and pressure chamber (D) is closed; the brake fluid exhibits the overpressure imposed on it. Since a fluid set under overpressure, transfers such pressure equally to all sides, the same overpressure conditions are conveyed to the pressure chamber (D′) via the secondary piston (2) and after the primary sleeve (4) has traveled over the compensating bore (A′). Almost the same amount of hydraulic overpressure prevails in both pressure chambers (FIG. 2b), which is detected by the two pressure sensors (10, 10′). In order to reduce the space requirements and for reasons of cost, only one pressure sensor (10 or 10′) may preferably be provided for certain applications.

The brake system of the vehicle is a dual circuit system due to the tandem brake master cylinder. If, for example, a leak should occur in the primary brake circuit (see FIG. 2c), no overpressure can be generated in the pressure chamber (D) when the brake pedal is pressed since the brake fluid escapes through the leak. In this case, pin (5) comes into contact with pin (6) and mechanically transfers the pedal force via the secondary piston (2) to the pressure chamber (D′). The connected secondary brake system remains effective.

According to the present invention, the pressure of the tandem brake master cylinder of the brake circuit is determined or estimated at least approximately on the basis of the signals of at least one vacuum pressure sensor in the brake booster, preferably through two vacuum sensors or one double vacuum sensor.

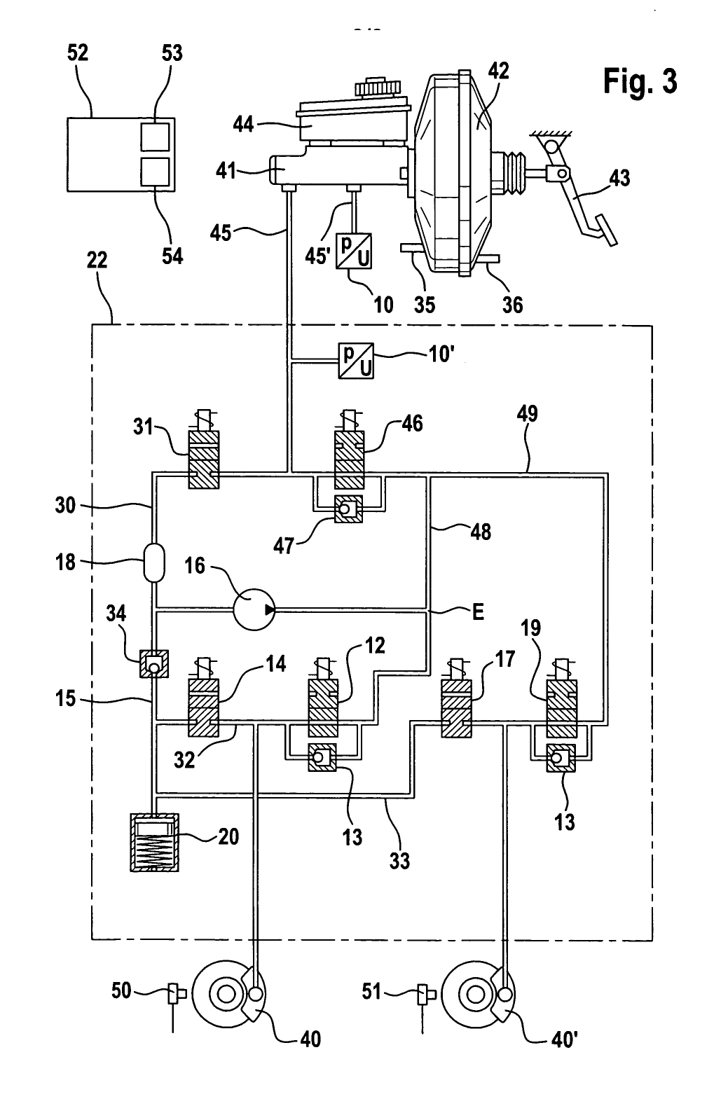

The dual-circuit brake system for vehicles shown in FIG. 3 comprises an actuating element 41, e.g. a tandem brake master cylinder, with a vacuum brake booster 42, which is actuated via a brake pedal 43. A tank 44 is arranged on the actuating element 41, which contains a certain volume of pressure fluid and, in the brake release position, is connected to the working chamber of the actuating element 41. The one brake circuit shown exhibits a brake line 45 that is connected to one working chamber of the actuating element 41, with such brake line 45 connecting the actuating element 41 with the hydraulic unit 22. The brake line 45 exhibits a block valve 46, which forms an open passage for the brake line 45 when in inoperative position. A non-return valve 47 that opens in the direction of the wheel brakes 40, 40′ is connected in parallel to the block valve 46. The block valve 46 also serves as pressure modulation unit here. A pressure limiting function is realized with this valve 46 by adjusting a certain control current with maximum limits. This offers the advantage that an otherwise necessary pressure limiting valve is not needed. The block valve 46 is activated electromagnetically. Preferably, the block valve 46 is an analog valve, because then continuous “analog” adjusting of the pressure or pressure reduction, in particular, is possible.

The brake line 45 forks into two brake lines 48, 49, each of which leads to a wheel brake 40, 40′ respectively. Each of the brake lines 48, 49 exhibit an electromagnetically actuated intake valve 12, 19, which is open in its inoperative position and can be switched to a lock position through excitation of the actuating magnet. A non-return valve 13 that opens in the direction of the brake cylinder 41 is connected in parallel to every intake valve 12, 19. A so-called return circuit, which comprises return lines 15, 32, 33 and a pump 16, is connected parallel to these wheel-brake circuits. The wheel brakes 40, 40′ are connected to the return line 15 via discharge valves 14, 17 and return lines 32, 33 respectively and, consequently, to the suction side of the pump 16, whose delivery side is connected to the brake pressure line 48 at junction E between the block valve 46 and intake valves 12, 19.

The pump 16 preferably is designed as a piston pump with a pressure valve and a suction valve, which are not shown in detail. In this case, the pump 16 is used as a booster unit to generate the additional hydraulic brake boosting. A low-pressure accumulator 20 consisting of a housing (not described in detail) with a spring and a piston is arranged on the suction side of the pump 16. A non-return valve 34 opening towards the pump is arranged in the connection between the low-pressure accumulator 20 and the pump 16. The suction side of the pump 16 is connected to the brake cylinder 41 via a suction channel 30 with a low-pressure damper 18 and a change-over valve 31.

The brake pressure in the two brake cylinders or brake-force transmission circuits is measured by the pressure sensors 10, 10′ and the (vacuum) pressure in the two chambers (working chamber and vacuum chamber) of the vacuum brake booster 42 is determined by the pressure sensors 35, 36. According to the present invention, the signals of at least one vacuum pressure sensor 35 or 36 of the brake booster, preferably of both vacuum sensors 35 and 36, are used to approximately determine or estimate the pressure in the tandem brake master cylinder of the brake circuits by means of a pressure determining unit 53 of an electronic brake regulating unit. A fault detection element 54 is associated to the electronic regulating unit 52 in order to detect a fault or the possible fault of a pressure sensor 10, 10′ on the basis of the estimated pressure in the tandem brake master cylinder of the brake circuits according to the signals of the vacuum pressure sensors 35 and/or 36 that were determined. The wheel speed is determined by the wheel-speed sensors 50, 51 and the signals are supplied to the electronic brake regulating unit 52.

The second brake circuit, which is not shown here for reasons of clarity, is connected to line 45′, and it is arranged analog to the first brake circuit described herein. The second brake circuit exhibits the same components with the same functions as the first brake circuit.

Under “normal circumstances” (without faults), the brake system operates as described below. When the driver increases the brake fluid pressure in the system, i.e. through the actuating element 41 with the vacuum brake booster 42, electronic regulating unit 52 causes the pump 16 to be activated to generate pressure in the wheel brakes when the point of maximum boosting of the vacuum brake booster 42 is reached or exceeded. In this way, the pneumatic brake boosting provided by the vacuum brake booster 42 is transferred to the brake boosting provided by the pump 16. The pump functions like an active hydraulic brake booster. If the brake pressure introduced to the system and the wheel brakes reaches or exceeds a value and if the wheels 40, 40′ are transformed into brake slip, then, according to the signals of the wheel-speed sensors 50, 51, ABS control is activated by the electronic regulating unit 52 and the intake and discharge valves 12, 14, 17, 19 are controlled accordingly.

If, for example, a brake circuit fails or a leakage occurs in the brake circuit (fault), then the brake system according to the present invention functions as follows. On the basis of the signals of the sensors 35, 36 in the brake booster 42 or on the basis of the signal of the working-chamber sensor 36 of the booster 42, the maximum point of the booster 42 is determined by the pressure determining unit 53. The maximum point of boosting is reached when the pressure in the working chamber is equal to the ambient atmospheric pressure.

If, for example, there is a leak in line 45 of the brake system, a circuit failure is determined by the fault detection element 54, since the hydraulic pressure determined by the pressure determining unit 53 is significantly lower than the pressure that should prevail when the maximum point is reached. Therefore, the signal of the associated pressure sensor 10′ cannot be used any longer as reference variable for active hydraulic brake boosting. When this is detected, the hydraulic boosting in the intact circuit (not shown here) is activated, i.e. at least up to the level required to fulfill the legal requirements. For this purpose, a hydraulic pump is used to gradually increase the pressure in the intact circuit (a pump analogous to pump 16 in the defective brake circuit). This continuous increase in pressure can be terminated when the driver begins to release the brake pedal because he considers the deceleration to be adequate and the booster 42 once again falls below the maximum point. In particular, this causes the pressure in the working chamber to drop below the atmospheric pressure again, and this is detected through the signals of the vacuum sensor 36 or vacuum sensors 35, 36. At this moment, the pressure increase caused by the pump of the intact brake circuit is interrupted and the brake pressure set at this point is maintained. If the driver continues to release the brake, pressure reduction is initiated through the analog block valve in the intact brake system (block valve analogous to valve 46 in the defective brake circuit). The end of the brake actuation is detected when the pressure in the working chamber is equal to the pressure in the vacuum chamber; then the brake pressure is reduced completely.

In order to prevent any unnecessary loss of brake fluid, no brake pressure is built up through pump 16 when a failure of the brake circuit with pressure sensor 10′ is definitely detected. Thus, valve 31 of this defective brake circuit is not opened anymore. At the same time, the wheel intake valves 12, 19 of this circuit are closed so that no brake fluid is lost if the brake is actuated again, for example, through an “overflow” of block valve 46. By means of this method, as much brake fluid as possible is retained in the system and braking action is achieved as long as possible. Also, because no brake fluid can be lost through “slopping losses” in the brake fluid tank 44 either, i.e. when brake fluid slops over a separating element arranged in the brake fluid tank 44 to separate circuits. In order to avoid any thermal overload of the intake valves 12, 19, these are closed, if necessary, only when the brake is actuated. This is so because the loss in brake fluid is greatest while the brake is being actuated. As a means of detection and, if necessary, control, the signals of the vacuum sensors 35, 36 and a brake-light switch can be used, for example.

All in all, the present invention, together with the available sensor system, the vacuum sensors 35, 36 in the booster 42 as well as the existing actuating elements, the pump 16 and valves, makes it possible to detect the driver's intention and a brake pressure suitable to the driver's specifications can be set even when a brake circuit with a pressure sensor fails or when there is a leak in this circuit. Thus, the driver can rely on having controllable braking action even when the circuit of the pressure-sensor circuit fails.

1-18. (canceled).

19. Method for determining a fault in or failure of a hydraulic pressure sensor or hydraulic brake circuit in a hydraulic vehicle brake system which includes a vacuum brake booster, comprising the step of:
determining a fault in or failure of a hydraulic pressure sensor or hydraulic brake circuit on the basis of a comparison between a hydraulic pressure or variables derived therefrom and a vacuum or a point of maximum boosting of the vacuum brake booster or variables derived therefrom.

20. Method according to claim 19, wherein the hydraulic pressure is determined by using at least one hydraulic pressure sensor and the vacuum or point of maximum boosting of the vacuum brake booster is determined by using one or several vacuum sensors.

21. Method according to claim 19, further including the step of:
detecting in the vacuum brake booster the vacuum or variables derived therefrom and comparing said vacuum or variables derived therefrom to the hydraulic pressure or variables derived therefrom and that a fault in or failure of the pressure sensor or associated brake circuit is concluded on the basis of such comparison.

22. Method according to claim 19, further including the hydraulic pressure with at least one hydraulic pressure sensor and determining the vacuum or point of maximum boosting of the vacuum brake booster with one or several vacuum sensors, wherein the pressures prevailing in a vacuum chamber and working chamber of the vacuum brake booster are determined by two vacuum sensors with respect to the ambient atmospheric pressure (ambient pressure) and the vacuum situation or point of maximum boosting of the vacuum brake booster is determined on the basis of these pressures.

23. Method according to claim 19, further including the step of:
determining the hydraulic pressure with at least one hydraulic pressure sensor and determining the vacuum or point of maximum boosting of the vacuum brake booster with one or several vacuum sensors, wherein the brake pressure to be introduced is determined on the basis of the signals of the vacuum sensor and the pressure sensor determines the brake pressure being applied and that the brake pressure to be introduced and the brake pressure being applied or variables derived therefrom are compared to each other and a fault in or failure of the pressure sensor or associated brake circuit is concluded from such comparison.

24. Method according to claim 19, further including the step of:
determining with at least one hydraulic pressure sensor and determining the vacuum or point of maximum boosting of the vacuum brake booster is determined with one or several vacuum sensors, wherein the brake pressure to be introduced is determined on the basis of the signals of the vacuum sensor and the pressure sensor determines the brake pressure being applied and that the brake pressure to be introduced and the brake pressure being applied or variables derived therefrom are compared to each other and a fault in or failure of the pressure sensor or associated brake circuit is concluded from such comparison, wherein a fault in or failure of the pressure sensor or associated brake circuit is concluded if the brake pressure to be introduced is at least approximately 10% greater than the brake pressure being applied.

25. Method according to claim 19, further including the step of:
concluding a fault in or failure of the pressure sensor or associated brake circuit if the vacuum situation or point of maximum boosting of the vacuum booster indicates that the driver wants to brake and this desire to brake is detected for at least a certain, predefined period of time and, at the same time, the hydraulic pressure in the brake circuit concerned is reduced or is very low already.

26. Method according to claim 19, further including the step of:
concluding a fault in or failure of the pressure sensor or associated brake circuit if the vacuum situation or point of maximum boosting of the vacuum booster indicates that the driver wants to brake and this desire to brake is detected for at least a certain, predefined period of time and, at the same time, the hydraulic pressure in the brake circuit concerned is reduced or is very low already, wherein a period of time ranging from about 10 sec. to about 150 sec. is specified.

27. Method according to claim 19, further including the step of:
concluding a fault in or failure of the pressure sensor or associated brake circuit if the vacuum situation or point of maximum boosting of the vacuum booster indicates that the driver wants to brake and this desire to brake is detected for at least a certain, predefined period of time and, at the same time, the hydraulic pressure in the brake circuit concerned is reduced or is very low already, wherein the driver's desire to brake is detected when the vacuum brake booster is essentially at its point of maximum boosting.

28. Method according to claim 19, further including the step of:
concluding a fault in or failure of the pressure sensor or associated brake circuit if the vacuum situation or point of maximum boosting of the vacuum booster indicates that the driver wants to brake and this desire to brake is detected for at least a certain, predefined period of time and, at the same time, the hydraulic pressure in the brake circuit concerned is reduced or is very low already, and the driver's desire to brake is detected when the vacuum brake booster is essentially at its point of maximum boosting, wherein the point of maximum boosting is determined on the basis of a pressure-to-pedal travel characteristic curve or a characteristic curve derived therefrom of the vacuum brake booster.

29. Method for brake boosting in a vehicle brake system with a hydraulic auxiliary force, comprising the steps of:
controlling the hydraulic auxiliary force in accordance with a fault in or a failure of a hydraulic pressure sensor or a hydraulic brake circuit, wherein determining said fault or failure of a hydraulic pressure sensor or hydraulic brake circuit is based upon a comparison between a hydraulic pressure or variables derived therefrom a vacuum or a point of maximum boosting of a vacuum brake booster or variables derived therefrom.

30. Method for brake boosting in a vehicle brake system with at least two brake circuits having at least one pressure sensor, comprising the steps of:
determining a fault in or failure of a hydraulic pressure sensor or hydraulic brake circuit, wherein when a fault in or failure of a hydraulic pressure sensor or hydraulic brake circuit is determined, hydraulic pressure is built up in a non-involved brake circuit or a brake circuit not associated with the failure.

31. Method according to claim 30, wherein hydraulic pressure is built up when the vacuum situation or point for a certain, predefined period of time that the driver conducts a brake maneuver and, at the same time, the hydraulic pressure in the brake circuit is reduced, and wherein the pressure increase continues when the vacuum situation or point of maximum boosting of the vacuum brake booster continues to indicate that the driver wishes to brake, and wherein the pressure increase is interrupted when the vacuum situation or point of maximum boosting of the vacuum brake booster no longer indicates that the driver wishes to brake.

32. Method according to claim 30, wherein hydraulic pressure is increased by closing a block valve that is arranged in a hydraulic line between the vacuum brake booster or a master brake cylinder connected thereto and a wheel brake, wherein an electric motor of a hydraulic pump which is arranged in the hydraulic line between the block valve and wheel brake is activated.

33. Method according to claim 30, wherein hydraulic pressure is reduced when the vacuum situation or point of maximum boosting of the vacuum brake booster indicates that the driver is releasing the brake.

34. Method according to claim 30, the method further including reducing hydraulic pressure when the vacuum situation or point of maximum boosting of the vacuum brake booster indicates that the driver is releasing the brake, wherein the hydraulic pressure is reduced by opening a block valve that is arranged in a hydraulic line between the vacuum brake booster or a master brake cylinder arranged directly downstream and a wheel brake, with the electric motor of a hydraulic pump, which is arranged in the hydraulic line between the block valve and the wheel brake, not being activated anymore for the purpose of generating pressure.

35. Method according to claim 30, the method including reducing hydraulic pressure by closing a block valve that is arranged in a hydraulic line between the vacuum brake booster or a master brake cylinder connected thereto and a wheel brake, and an electric motor of a hydraulic pump which is arranged in the hydraulic line between the block valve and wheel brake is activated, wherein the block valve is an analog electromagnetic valve.

36. Method according to claim 30, further including activating the valves arranged in the brake circuit in such a way that a loss or additional loss of brake fluid is prevented when a fault or failure is determined in the brake circuit.
